(19) United States
(12) Patent Application Publication
(10) Pub. No.: US 2026/0002504 A1
(43) Pub. Date: Jan. 1, 2026

(54) Unknow

(71) Applicant: TGE Marine Gas Engineering GmbH, Bonn (DE)

(72) Inventors: Olaf Beyer, Königswinter (DE); Tobias Zacheja, Sankt Augustin (DE); Julius Wellen, Köln (DE)

(73) Assignee: TGE Marine Gas Engineering GmbH, Bonn (DE)

(21) Appl. No.: 19/218,957

(22) Filed: May 27, 2025

(30) Foreign Application Priority Data
May 28, 2024 (DE) 102024114980.9

(51) Int. Cl. F02M 37/00; B63B 17/00; F02M 31/20

(52) U.S. Cl. CPC F02M 37/0052; B63B 17/0027; F02M 31/20; F02M 37/0023; F02M 37/0076

(57) ABSTRACT

The invention relates to a return system (2) for returning recirculated propulsion liquefied petroleum gas, in particular, recirculated propulsion liquefied petroleum gas of a main engine (4) and/or auxiliary engine (6) of a ship (100).

According to the invention, it is proposed that the return system (2) comprises a recovery device (8), wherein the recovery device (8) is connected by a supply line (10a, 10b) to a main engine (4) or an auxiliary engine (6) in a fluid-conducting manner and comprises a cooling device (26) which is configured to cool the recirculation flow (12a, 12b) supplied by the main engine (4) and/or the auxiliary engine (6), a gas supply system (14), which is configured to supply propulsion liquefied petroleum gas to the main engine (4) or the auxiliary engine (6), wherein the gas supply system (14) is connected to the recovery device (8) via a recirculation line (16) in a in a fluid-conducting manner and wherein a control valve (18) is assigned to the recirculation line (16) for setting a fluid flow through the recirculation line (16), and a recirculation tank (20), which is connected via an inlet line (22) is connected to the recovery device (8) and via an outlet line (24) to the gas supply system (14).

The invention relates to a return system for returning recirculated propulsion liquefied petroleum gas, in particular, recirculated propulsion liquefied petroleum gas of a main engine and/or auxiliary engine of a ship.

In the maritime industry, the climate targets set by the International Maritime Organisation (IMO) and other intergovernmental organisations aim to decarbonize shipping. One way to achieve this goal is to use alternative fuels that do not contain carbon, such as ammonia for example. Combustion engines that can be operated with both conventional fuels and ammonia as well as the associated ammonia fuel injection systems are currently under development. Such combustion engines are also known as dual-fuel engines.

A large proportion of the combustion engines already known or currently under development have liquid injection, wherein propulsion liquefied petroleum gas, also known as fuel gas, which is not used by the combustion engine, occurs in the form of so-called recirculation flows and is to be supplied back into the main engine or auxiliary engine as efficiently as possible.

A major challenge here is to avoid the occurrence of so-called flash gas within a relevant recirculation system or a gas supply system for the main engine or auxiliary engine. In addition, a key objective is to prevent the solidification of potential oil content within the recirculation flow and in the gas supply system and to reduce the overall energy consumption of the relevant return systems.

Against this background, the invention was based on the task of further developing a return system of the type mentioned at the beginning in such a way that the disadvantages found in prior art were eliminated as far as possible. In particular, an efficient return system is to be specified, which is to be operated in an energy-saving manner and is intended to ensure improved utilization of the propulsion liquefied petroleum gas ammonia or alternative propulsion liquefied petroleum gases.

According to the invention, the task of a return system of the type mentioned at the outlet is achieved it that it comprises a recovery device, wherein the recovery device is connected to a main engine or an auxiliary engine via a supply line in a fluid-conducting manner and comprises a cooling device which is configured to cool the recirculation flow supplied by the main engine and/or auxiliary engine, a gas supply system which is configured to supply propulsion liquefied petroleum gas to the main engine or auxiliary engine, wherein the gas supply system is connected to the recovery device via a recirculation line in a fluid-conducting manner and wherein the recirculation line is assigned a control valve for setting a fluid flow through the recirculation line and a recirculation tank which is connected to the recovery device via an inlet line and via an outlet line with gas supply system.

The invention makes use of the knowledge that the recirculation flows, which usually comprise a temperature greater than 60° Celsius, can be cooled by the use of a cooling device in the recovery device. The cooling of the recirculation flows with the help of the recovery device and the subsequent supplying of the cooled recirculation flows to a gas supply system is an efficient way of reusing the recirculated gas as propulsion liquefied petroleum gas during normal operation of the main engine or auxiliary engine when using ammonia as propulsion liquefied petroleum gas for example.

In the event that the return system is to be emptied of propulsion liquefied petroleum gas, inert gases, such as nitrogen for example, are usually used to flush the system. Conversely, nitrogen is in the lines after a flushing process and must be discharged from them if operation is to be resumed with propulsion liquefied petroleum gas, such as ammonia for example. In this respect, the invention makes use of the knowledge that it has proven to be favourable to supply the flows in question to a recirculation tank which serves both as a collection tank as well as a liquefied petroleum gas separator. Preferably, the recirculation tank is operated at a lower pressure level than the recovery device and below the saturation pressure associated with the saturation temperature so that so-called flash gas is produced in the recirculation tank. In addition, larger quantities of nitrogen are also collected in the tank, wherein the nitrogen is typically used to flush the return system and can be collected in the recirculation tank together with propulsion liquefied petroleum gas.

The combination of the recovery device according to the invention, the gas supply system and the recirculation tank thus makes it possible to maximize the retention of the ammonia or fuel gas in the system in all operating scenarios, i.e., both during normal operation as well as during flushing processes or when the system switches to the use of propulsion liquefied petroleum gas, for example, ammonia. By supplying the recirculation flows to the gas supply system and from there again to the main engine and/or auxiliary engine, the fuel gas resource is handled particularly efficiently. The specific energy consumption of the plant is also reduced, as the amount of fuel gas to be pumped by the gas supply system is reduced.

In accordance with an embodiment, the return system comprises a control device which is configured to release the control valve of the recirculation line in a first operating mode so that the recirculation flow is in particular completely supplied to the gas supply system, and to shut off the control valve in a second operating mode so that recirculated propulsion liquefied petroleum gas is supplied to the recirculation tank by the recirculation device. Thereby, the control device enables automated switching between the individual operating modes, i.e., in particular, between the normal operating mode, in which the recirculation flow is to be completely supplied into the gas supply system, as well as the operating mode or those operating modes, in which the return system is either to be filled with fuel gas or freed from it. In this case, the mixture of nitrogen and fuel gas is first supplied into the recirculation tank.

In accordance with an embodiment, a pressure sensor is assigned to the recirculation line for sensing a fluid pressure in the recirculation line, wherein the control device is configured in the first operating mode by controlling the control valve to set a back pressure in the supply line in such a way that the recirculation flow remains in the liquid phase. The flows in question are then supplied directly into the gas supply system, bypassing the recirculation tank, so to speak. The control valve and thus the setting of the back pressure is preferably carried out in such a way that no gas is produced in the recirculation line and/or the flash gas content that occurs during expansion via the control valve is minimized as much as possible.

In accordance with an embodiment, a level sensor is assigned to the recirculation tank, which is configured to sense a fluid level in the recirculation tank, wherein the level sensor is connected to the control device in a data-conducting manner and the control device is configured to release the outlet line when a defined level in the recirculation tank is exceeded. In other words, if liquid accumulates in the recirculation tank and exceeds a defined level, the recirculation tank can be emptied as completely as possible in the direction of the gas supply system, without gas being supplied to the gas supply system but rather only liquid.

In accordance with an embodiment, the return system comprises a bypass line capable of being shut off that connects the supply line directly to the inlet line in a fluid-conducting manner, wherein a pressure sensor is assigned to the recirculation tank, which is configured to sense an internal pressure in the recirculation tank, and wherein the pressure sensor is connected in a data-conducting manner to a control device which is configured to direct the recirculation flow via the bypass line to the recirculation tank if the recirculation tank falls below a defined minimum pressure. Within the framework of this minimum pressure control, the aim is to keep the pressure in the recirculation tank at a minimum value so that potentially collected liquid can be discharged. Pressure measurement is preferably carried out on the tank by means of a pressure transmitter. If the pressure drops below a defined minimum pressure, warm recirculated gas is supplied to the recirculation tank via the bypass line, which does not pass through the cooling device of the recovery device. This warm gas increases the pressure in the tank. Once the defined minimum pressure has been reached, the supply of warm gas via the bypass line can be stopped.

In accordance with an embodiment, the internal pressure in the recirculation tank is controlled in such a way that it is greater than the fluid pressure in a supply line to a high-pressure pump of the gas supply system.

In accordance with an embodiment, the system comprises a collection tank that is connected to the recirculation tank by a line that comprises a drain valve, and wherein the control device is configured to open the drain valve when a defined maximum pressure in the recirculation tank is exceeded. By opening the drain valve, excess gas is released so that the pressure in the recirculation tank is reduced again.

In accordance with an embodiment, the gas supply system comprises a recondenser, wherein the recirculation line is connected in a fluid-conducting manner to the recondenser, in particular, wherein the gas supply system also comprises a compression device connected in a fluid-conducting manner to the recondenser, which is configured to transfer the recirculated propulsion liquefied petroleum gas and the propulsion liquefied petroleum gas taken from a liquefied petroleum gas tank to an inlet pressure of the main engine or auxiliary engine.

The gas supply system enables the merging of recirculation flows and fuel gas flows from the liquefied petroleum gas tank as well as an appropriate treatment, in particular, a pressurization of the propulsion liquefied petroleum gas to an inlet pressure of the main engine or auxiliary engine.

In accordance with an embodiment, the recondenser is connected to a liquefied petroleum gas tank via a liquefied petroleum gas line in a fluid-conducting manner, wherein a heating device is assigned to the liquefied petroleum gas line, which is configured to heat the propulsion liquefied petroleum gas to a temperature above a solidification point of a machine oil contained in the recirculation flows. Recirculation flows can always be contaminated with machine oil. By providing a heating device, the fuel gas can be heated to prevent the oil from solidifying. Heating is preferably required only if the recirculation flows contain oil with a pique point above the atmospheric saturation temperature of the ammonia. Preferably, a heating device is used for the purpose of heating the oil. Alternatively, bypass flows from the compression device can be added to a cold liquid flow so that the mixing temperature is within the required range.

Preferably, the pressure in the recirculation tank is kept above the pressure of the liquid inflow to the recondenser so that the collected liquid can be supplied to the recondenser through the pressure difference. The selected pressure level also ensures that the liquid in the recirculation tank is supplied back into the process preferentially than the liquid pumped back from the liquefied petroleum gas tank. The pressure control in the recirculation tank is preferably chosen in such a way that the pressure is sufficient to supply the liquid to the recondenser in sufficient quantities and, on the other hand, the amount of flash gas produced during expansion via the control valve or into the recirculation tank is kept as low as possible. In accordance with an embodiment, in the event that the return system is emptied and flushed with inert gas, in particular, nitrogen, valves of the individual recirculation lines are opened, which, in turn, supply a mixture of liquid and gas to the recirculation tank.

In accordance with an embodiment, the recirculation flows supplied to the recondenser originate either from the recirculation tank or from the back pressure control of the recirculation system. The flows in question preferably comprise a gas component. The pressure level and the amount of liquid supply flow originating from the liquefied petroleum gas tank is preferably conditioned in such a way that there is sufficient supercooling so that the flash gas portion of the recirculation flow can be fully absorbed. Preferably, supercooling is also selected in such a way that residual supercooling remains for the subsequent operation of the compression device, in particular, a high-pressure fuel gas pump. In accordance with an embodiment, in addition to the actual recondensation, the recondenser ensures that the supplied flows are mixed as homogeneously as possible.

Overall, the return system according to the invention comprises the following advantages: On the one hand, the time the product stays in the system is maximized in all operating scenarios. On the other hand, the efficient treatment of the fuel gas is effected by supplying the recirculation flows into the outlets to the engines, i.e., the main engine and/or at least one auxiliary engine. Furthermore, the solidification of potential oil components is prevented by the appropriate temperature management of the recirculation flows and the fuel gas flows in general. In addition, the specific energy consumption of the system is also reduced, as the amount of fluid to be pumped by the high-pressure pumps is reduced. The process control also provides a cost-effective return system, since, on the one hand, the design pressure of the recirculation tank can be below the design pressure of the return system and on the other hand the permanent recirculation flows are guided past the recirculation tank.

The invention has been described above with reference to a return system. In another aspect, the invention relates to a ship, in particular, a cargo ship, with a liquefied petroleum gas propulsion system and a return system for returning propulsion liquefied petroleum gas. Preferably, the liquefied petroleum gas propulsion system is designed as a dual-fuel propulsion system, i.e. it is configured to be used in addition to a conventional fuel, such as e.g. heavy oil, to be operated with ammonia. The invention solves the problem described at the beginning with regard to the ship by designing the return system according to one of the aforementioned claims. The ship makes use of the same advantages and preferred embodiments as the return system according to the invention and vice versa. In this regard, reference is made to the above embodiments; and their content is hereby included.

In a further aspect, the invention relates to a method for returning recirculated propulsion liquefied petroleum gas with a return system according to one of the aforementioned exemplary embodiments. The method comprises the following steps: Supplying a recirculation flow from a main engine and/or auxiliary engine to a recovery device, cooling of the recirculation flow in the recovery device, supplying of the cooled recirculation flow to a gas supply system, in particular, a recondenser of the gas supply system, wherein a back pressure of the recirculation flow, in particular, in a supply line, is configured in such a way that the recirculation flow in the liquid phase remains, or supplying the cooled recirculation flow to a recirculation tank and collecting the recirculated propulsion liquefied petroleum gas in the recirculation tank.

The method makes use of the knowledge that, during the regular operation of the main engine and/or auxiliary engine, the recirculation flow is supplied back to the main engine and/or auxiliary engine after further treatment steps, wherein the setting of the back pressure ensures that the recirculation flow remains in the liquid phase. In scenarios in which, for example, an ammonia operation is to be started or the system is to be flushed after such operation, the recirculation flows that occur in these scenarios, for example, also the gas used for flushing, for example, nitrogen can be supplied into a recirculation tank and collected there.

The method is further developed via the following steps: Flushing the return system with inert gas, collecting the inert gas used for flushing in the recirculation tank.

The method is furthermore developed via the following steps: Supply of an uncooled recirculation flow via a bypass line to the recirculation tank if a defined minimum pressure in the recirculation tank falls short, and/or opening of a drain valve of the recirculation tank if a defined maximum pressure in the recirculation tank is exceeded. In this way, the pressure within the recirculation tank can be controlled between a minimum pressure and a maximum pressure.

In accordance with an embodiment, the method also comprises the following steps: Supplying propulsion liquefied petroleum gas from an liquefied petroleum gas tank to a recondenser of the gas supply system, wherein the propulsion liquefied petroleum gas from the liquefied petroleum gas tank is heated to a temperature above one solidification point of the machine oil contained in the recirculation flows, providing the cooled recirculation flow to the recondenser, mixing the propulsion gas from the liquefied petroleum gas tank and the cooled recirculation flow, imposing the mixture and providing the propulsion gas onto a main engine and/or auxiliary engine. The proposed heating prevents the machine oil from solidifying.

In a further aspect, the invention relates to the use of a return system according to one of the above exemplary embodiments for the return of recirculated propulsion liquefied petroleum gas intended for the propulsion of a main engine or of one or a plurality of auxiliary engines of a ship. In particular, the propulsion liquefied petroleum gas is selected from the list, comprising: LPG, ammonia, methanol.

The use of a return system according to the invention has proven to be particularly important in the use of so-called dual-fuel engines, which are used on the one hand with classical fuels, for example, heavy fuel oil, and also with one of the fuels mentioned, particularly ammonia.

The invention is described in more detail below on the basis of preferred exemplary embodiments with reference to the attached figures.

Hereby, the figures show:

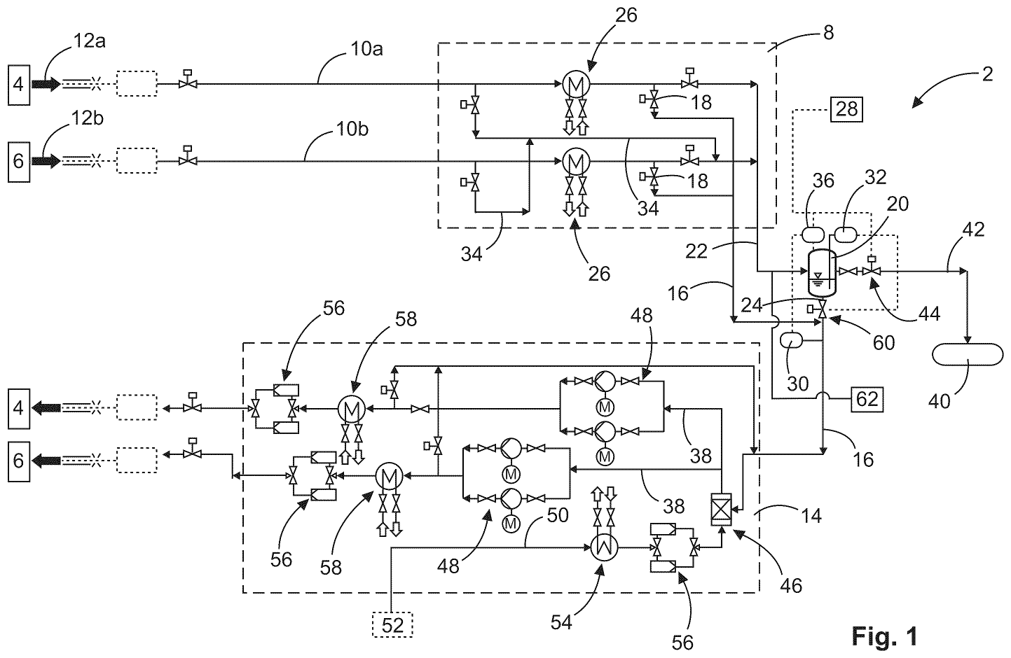

FIG. 1 a return system according to the invention in a schematic illustration;

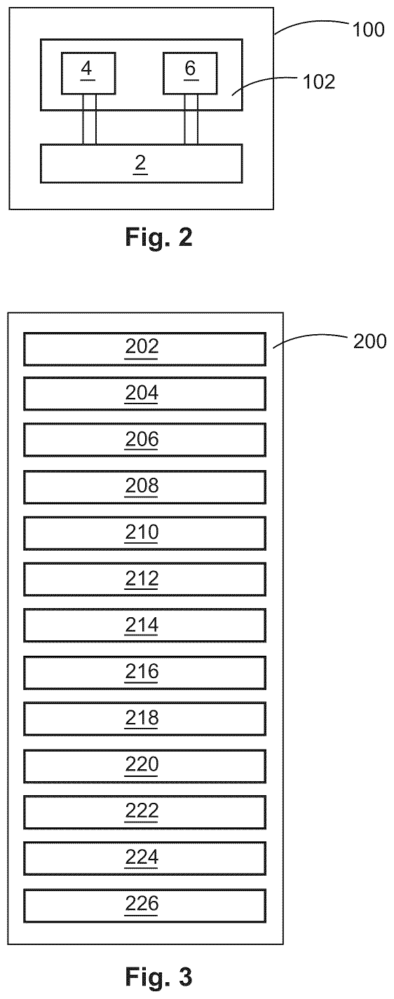

FIG. 2 a ship according to the invention with a return system in a schematic illustration; and

FIG. 3 a block diagram of a method according to the invention.

FIG. 1 shows a return system 2 for the return of recirculated propulsion liquefied petroleum gas from a main engine 4 and an auxiliary engine 6 of a ship 100 (see FIG. 2). In the exemplary embodiment in FIG. 1, exactly one main engine 4 and one auxiliary engine 6 are shown as examples. However, it is also possible to operate one or a plurality of main engines 4 and/or one or a plurality of auxiliary engines 6 with the corresponding return system 2. A recirculation flow 12a arises from the main engine 4 and a recirculation flow 12b from the auxiliary engine 6. The two recirculation flows 12a, 12b are supplied to a recovery device 8 via supply lines 10a and 10b. The recovery device 8 comprises a cooling device 26 for each recirculation flow 12a, 12b. The cooling device 26 is configured to cool the recirculation flow 12a, 12b supplied by the main engine 4 and auxiliary engine 6. In the flow direction behind the cooling device 26, the cooling device 26 is connected to a recirculation tank 20, on the one hand, via an inlet line 22 and, on the other hand, to a gas supply system, in particular, a recondenser 46 of the gas supply system, via the recirculation line 16 by means of an intermediate control valve 18. A return tank 62 is also connected to the inlet line 22 in a fluid-conducting manner. A valve 60 is provided in the area of the outlet line.

In addition, bypass lines 34 are arranged upstream to cooling devices 26 and are configured to supply hot gas, i.e., gas which has not yet been cooled by cooling devices 26, to recirculation tank 20. The bypass line 34 can be shut off by valves. The control valve 18 allows a fluid flow to be set via the recirculation line 16. The recirculation tank 20 is connected to the recovery device 8 via the inlet line 22 and also to the gas supply system 14, in particular the recondenser 46, via an outlet line 24.

The return system 2 also comprises a control device 28. This is configured to release the control valve 18 of the recirculation line 16 in a first operating mode so that the recirculation flow 12a, 12b, in particular, is completely supplied to the gas supply system 14 and to shut off the control valve 18 in a second operating mode so that recirculated propulsion liquefied petroleum gas is supplied to the recirculation tank 20 from the recovery device 8. A pressure sensor 30 is assigned to the recirculation line 16. The pressure sensor 30 is configured to sense the fluid pressure in the recirculation line 16. The control device 28 is also configured to set a back pressure in the supply line 10a, 10b in the first mode of operation by controlling the control valve 18 in such a way that the recirculation flow 12a, 12b remains in the liquid phase. A level sensor 32 is assigned to the recirculation tank 20. The level sensor 32 is configured to sense a fluid level in the recirculation tank 20. The level sensor 32 is connected to the control device 28 in a data-conducting manner. The control device 28 is configured to open valve 60 and release the liquid through outlet line 24 when a defined level in recirculation tank 20 is exceeded.

A pressure sensor 36 is also assigned to the recirculation tank 20. The pressure sensor 36 is configured to sense an internal pressure in the recirculation tank 20. The pressure sensor 36 is connected to the control device 28 in a data-conveying manner. Control device 28 is configured to supply the recirculation flow 12a, 12b to the recirculation tank 20 via the bypass line 34 if a defined minimum pressure in the recirculation tank 20 is not reached. In this case, uncooled recirculated fluid is supplied to the recirculation tank 20, which does not pass through the cooling devices 26. The internal pressure in the recirculation tank 20 is also controlled in such a way that it is greater than the fluid pressure in the liquefied petroleum gas supply into the recondenser 46. The pressure at the inlet of the recondenser 46 is higher than that in the supply lines 38.

The return system 2 also comprises a collection tank 40. The collection tank 40 is connected to the recirculation tank 20 via a line 42, which comprises a drain valve 44. Control device 28 is configured to open the drain valve 44 when a defined maximum pressure in the recirculation tank 20 is exceeded. The recirculation line 16 and the outlet line 24 are connected to the recondenser 46 in a fluid-conducting manner. The gas supply system 14 comprises a compression device 48 connected in a fluid-conducting manner to the recondenser 46, which is also referred to as a high-pressure pump. Compression device 48 is configured to impose the recirculated propulsion liquefied petroleum gas and the propulsion liquefied petroleum gas taken from an liquefied petroleum gas tank 52 onto an inlet pressure of the main engine 4. Downstream from the compression device 48, a heat exchanger 58 is also provided, as well as a filter 56 downstream from this. From there, the pressurized and filtered fuel gas is transported to the main engine 4 or auxiliary engine 6. The auxiliary engine 6 is also connected to the recondenser 46 in the same way. The recondenser 46 is connected to a compression device 48 via a supply line 38. The compressed fluid passes from there to the auxiliary engine 6 after passing through a heat exchanger 58 and a filter 56. During operation, either the recirculation flow 12a, 12b is supplied to the recirculation tank 20 or a fluid flow originating from the return tank 62, but preferably not both flows simultaneously, which preferably affects the dimensioning of the recirculation tank 20.

The liquefied petroleum gas tank 52 is connected to a heating device 54 via a line 50. The fuel gas taken from tank 52 is transferred from there to the recondenser 46 after passing through a filter 56. The heating device 54 is used to heat the propulsion liquefied petroleum gas to a temperature above a solidification point of an engine oil contained in the recirculation flows 12a, 12b.

FIG. 2 shows a ship 100 in the form of a schematic representation. The ship 100 is specially designed as a cargo ship. The ship 100 comprises a liquefied petroleum gas propulsion system 102, which is preferably designed as a dual-fuel propulsion system. The ship 100 also comprises a return system 2, wherein the return system 2 is preferably designed as shown in FIG. 1. The return system 2 is connected to the main engine 4 or the auxiliary engine 6 via supply lines 10a, 10b in a fluid-conducting manner.

FIG. 3 shows a block diagram of a method 200 according to the invention. The method 200 comprises the following steps: Supplying 202 of a recirculation flow 12a, 12b of a main engine 4 and/or an auxiliary engine 6 to a recovery device 8, cooling 204 of the recirculation flow 12a, 12b in the recovery device 8, supplying 206 of the refrigerated recirculation flow 12a, 12b to a gas supply system 14, in particular, a recondenser 46 of the gas supply system 14, wherein a back pressure in the supply line 10a, 10b is set in such a way that the recirculation flow 12a, 12b remains in the liquid phase, or supplying 208 of the cooled recirculation flow 12a, 12b to a recirculation tank 20 and collecting the recirculated propulsion liquefied petroleum gas in the recirculation tank 20, flushing 210 of the return system 2 with inert gas, collecting 212 of the inert gas used for flushing in the recirculation tank 20, supplying 214 of an uncooled recirculation flow 12a, 12b via a bypass line 34 to the recirculation tank 20 if a defined minimum pressure in the recirculation tank 20 falls short, and/or opening 216 of a drain valve 44 of the recirculation tank 20 if a defined maximum pressure in the recirculation tank 20 is exceeded, providing 220 of propulsion liquefied petroleum gas from a liquefied petroleum gas tank 52 to a recondenser 46 of the gas supply system 14, wherein the propulsion liquefied petroleum gas from the liquefied petroleum gas tank 52 is heated to a temperature above of a solidification point of the engine oil contained in the recirculation flows 12a, 12b, providing 222 of the cooled recirculation flow 12a, 12b to the recondenser 46, mixing 224 of the propulsion gas from the liquefied petroleum gas tank 52 and the cooled recirculation flow 12a, 12b, imposing 226 of the mixture and providing the propulsion gas onto a main engine 4 and/or auxiliary engine 6. The method was presented in FIG. 3 in a coherent manner. However, according to the invention, the method may also comprise only one of the steps shown or a combination of them.

### REFERENCE LIST

2 return system
4 main engine
6 auxiliary engine
8 recovery device
10a supply line, main engine
10b supply line, auxiliary engine
12A recirculation flow, main engine
12b recirculation flow, auxiliary engine
14 gas supply system
16 recirculation line
18 control valve for setting a fluid flow through the recirculation line
20 recirculation tank
22 inlet line
24 outlet line
26 cooling device
28 control device
30 pressure sensor of the recirculation line and/or outlet line
32 level sensor of the recirculation tank
34 bypass line
36 pressure sensor of the recirculation tank
38 high-pressure pump supply line
40 collection tank
42 line
44 drain valve
46 recondenser
48 compression device
50 liquefied petroleum gas line from the liquefied petroleum gas tank
52 liquefied petroleum gas tank
54 heating device
56 filter
58 heat exchanger
60 valve
62 return tank
100 ship
102 liquefied petroleum gas propulsion system
200 method
202 supplying a recirculation flow to a recovery device
204 cooling of the recirculation flow in the recovery device
206 supplying the cooled recirculation flow to a gas supply system
208 supplying the cooled recirculation flow to a recirculation tank
210 flushing of the return system with inert gas,
212 collection of the inert gas used for flushing in the recirculation tank
214 supplying of an uncooled recirculation flow via a bypass line
216 opening of a drain valve of the recirculation tank when a defined maximum pressure in the recirculation tank is exceeded
218 supplying of collected liquid from a return tank to the recirculation tank
220 providing propulsion liquefied petroleum gas from an liquefied petroleum gas tank to a recondenser of the gas supply system
222 providing the cooled recirculation flow to the recondenser
224 mixing of the propulsion gas from the liquefied petroleum gas tank and the cooled recirculation flow
226 imposing the mixture and supplying the propulsion gas onto a main engine or auxiliary engine

1. A return system for returning recirculated propulsion liquefied petroleum gas, in particular, recirculated propulsion liquefied petroleum gas of a main engine and/or auxiliary engine of a ship, with:
a recovery device, wherein the recovery device is connected by a supply line to a main engine or an auxiliary engine in a fluid-conducting manner and comprises a cooling device which is configured to cool a recirculation flow supplied by the main engine and/or the auxiliary engine,
a gas supply system, which is configured to provide propulsion liquefied petroleum gas to the main engine or the auxiliary engine, wherein the gas supply system is connected to the recovery device via a recirculation line in a fluid-conducting manner and wherein a control valve is assigned to the recirculation line for setting a fluid flow through the recirculation line,
and a recirculation tank, which is connected to the recovery device via an inlet line and to the gas supply system via an outlet line.

2. The return system according to claim 1, with a control device which is configured:
a) in a first mode of operation, to release the control valve of the recirculation line so that the recirculation flow is, in particular, completely supplied into the gas supply system, and
b) to shut off the control valve in a second mode of operation so that recirculated propulsion liquefied petroleum gas is supplied to the recirculation tank by the recovery device.

3. The return system according to claim 2,
wherein a pressure sensor is assigned to the recirculation line for sensing a fluid pressure in the recirculation line, wherein the control device is configured to set a back pressure in the supply line in the first mode of operation by controlling the control valve in such a way that the recirculation flow remains in a liquid phase.

4. The return system according to claim 1,
wherein a level sensor is assigned to the recirculation tank, which is configured to sensing a fluid level in the recirculation tank, wherein the level sensor is connected to the control device in a data-conducting manner and the control device is configured to release the outlet line when a defined level in the recirculation tank is exceeded.

5. The return system according to claim 3,
with a bypass line capable of being shut off, which connects the supply line directly with the inlet line in a fluid-conducting manner,
wherein a pressure sensor is assigned to the recirculation tank, which is configured to sense an internal pressure in the recirculation tank, and wherein the pressure sensor is connected in a data-conducting manner to the control device, which is configured to supply the recirculation flow via the bypass line to the recirculation tank if a defined minimum pressure in the recirculation tank falls short, and in particular, wherein the internal pressure in the recirculation tank is controlled in such a way that it is greater than the fluid pressure in a supply line to a high-pressure pump of the gas supply system.

6. The return system according to claim 2,
wherein the return system comprises a collection tank which is connected to the recirculation tank by a line which comprises a drain valve, and wherein the control device is configured to open the drain valve when a defined maximum pressure in the recirculation tank is exceeded.

7. The return system according to claim 1,
wherein the gas supply system comprises a recondenser and wherein the recirculation line is connected to the recondenser in a fluid-conducting manner, in particular wherein the gas supply system also comprises a compression device connected in a fluid-conducting manner to the recondenser, which is configured to transfer the recirculated propulsion liquefied petroleum gas and the propulsion liquefied petroleum gas taken from a liquefied petroleum gas tank to an inlet pressure of the main engine or auxiliary engine.

8. The return system according to claim 7,
wherein the recondenser is connected to a liquefied petroleum gas tank via a liquefied petroleum gas line in a fluid-conducting manner and wherein a heating device is assigned to the liquefied petroleum gas line, which is configured to heat the propulsion liquefied petroleum gas to a temperature above a solidification point of a machine oil contained in the recirculation flows.

9. A ship, in particular a cargo ship, having a liquefied petroleum gas propulsion system and a return system for the recirculation of recirculated propulsion liquefied petroleum gas, wherein the return system is designed to claim 1.

10. A method for the recirculation of recirculated propulsion liquefied petroleum gas using a return system according to claim 1, wherein method comprises the steps:
supplying of a recirculation flow of a main engine and/or auxiliary engine to a recovery device,
cooling of the recirculation flow in the recovery device,
supplying of the cooled recirculation flow to a gas supply system, in particular a recondenser of the gas supply system,
wherein a counterpressure of the recirculation flow, in particular in a supply line, is set in such a way that the recirculation flow remains in liquid phase, or
supplying of the cooled recirculation flow to a recirculation tank and collecting the recirculated propulsion liquefied petroleum gas in the recirculation tank.

11. The method according to claim 10, comprising the steps:
flushing of the return system with inert gas, and
collecting the inert gas used for flushing in the recirculation tank.

12. The method according to any one of claim 10, comprising the steps:
supplying of an uncooled recirculation flow via a bypass line to the recirculation tank if a defined minimum pressure in the recirculation tank falls short, and/or
opening of a drain valve of the recirculation tank when a defined maximum pressure in the recirculation tank is exceeded.

13. The method according to claim 10, comprising the steps:
providing propulsion liquefied petroleum gas from a liquefied petroleum gas tank to a recondenser of the gas supply system, wherein the propulsion liquefied petroleum gas from the liquefied petroleum gas tank is heated to a temperature above a solidification point of a machine oil contained in the recirculation flows,
providing of the cooled recirculation flow to the recondenser,
mixing of the propulsion gas from the liquefied petroleum gas tank and the cooled recirculation flow, and
imposing of the mixture and supplying the propulsion gas onto a main engine and/or auxiliary engine.

14. Use of a return system according to claim 1 for the recirculation of recirculated propulsion liquefied petroleum gas intended for propulsion of a main engine or auxiliary engines of a ship, in particular, wherein the propulsion liquefied petroleum gas or propulsion fluid is selected from:
LPG,
ammonia, and
methanol.
